(19) United States
(12) Patent Application Publication
(10) Pub. No.: US 2015/0096438 A1
(43) Pub. Date: Apr. 9, 2015

(54) CYLINDER ASSEMBLY WITH A CYLINDER POSITION SENSOR

(71) Applicant: Caterpillar Inc., Peoria, IL (US)

(72) Inventor: Michael Subrt, Chillicothe, IL (US)

(73) Assignee: Caterpillar Inc., Peoria, IL (US)

(21) Appl. No.: 14/045,196

(22) Filed: Oct. 3, 2013

(51) Int. Cl. F16J 10/02

(52) U.S. Cl. CPC F16J 10/02
USPC 92/169.1

(57) ABSTRACT

A cylinder assembly is provided. The cylinder assembly includes a cylinder body, a rod member, and a cylinder position sensor assembly. The cylinder body may have a bearing sleeve to support the rod member. The cylinder position sensor assembly may include a cylinder position sensor for sensing the position of the rod member. The cylinder position sensor assembly may be mounted inside a hole in the bearing sleeve.

### TECHNICAL FIELD

The present disclosure relates to a cylinder position sensor for a hydraulic cylinder. More specifically, the present disclosure relates to mounting of a cylinder position sensor into a bearing sleeve of the hydraulic cylinder.

### BACKGROUND

A hydraulic cylinder having a movable piston and rod member is widely used in industrial, earthmoving and material handling machines and vehicles. Introducing an automated system for automatically controlling an extension and retraction of the piston and rod assembly may partially or totally automate work operation of the hydraulic cylinder. In such an automated system, a cylinder position sensor may be used to determine a position of the piston and rod member within the hydraulic cylinder. However one of the various challenges faced while using such a position sensor, apart from robustness and accuracy, may be a mounting method for coupling the cylinder position sensor with the hydraulic cylinder. Such a mounting method may involve high mounting cost and may require an accurate alignment of the cylinder position sensor with respect to the piston and rod assembly. For example, when a cylinder position sensor mount is affixed directly to the end of hydraulic cylinder, alignment of the cylinder position sensor with rod may be affected. Due to the improper alignment, the cylinder position sensor may cause errors in sensing the position of the rod. The errors may lead to inappropriate results and lack in accuracy.

Various solutions have been developed to provide an arrangement that can overcome the challenges cited above.

### SUMMARY OF THE DISCLOSURE

The present disclosure provides a cylinder assembly. The cylinder assembly may include a cylinder body. The cylinder body can be a hollow cylinder including a head end and a rod end. Further the cylinder assembly includes a rod member. The rod member can be configured to engage in a telescopic motion within the cylinder body. Moreover the cylinder assembly includes a bearing sleeve disposed inside the cylinder body at the rod end. The bearing sleeve includes a hole. Furthermore, the cylinder assembly includes a cylinder position sensor assembly. The cylinder position sensor assembly can be mounted in the hole of the bearing sleeve. The cylinder position sensor assembly can include a cylinder position sensor for sensing the position of the rod member.

### BRIEF DESCRIPTION OF THE DRAWINGS

FIG. 1 is a longitudinal sectional view of a cylinder assembly, according to an embodiment of the present disclosure; and

FIG. 2 is a fragmentary cutaway view of a cylinder position sensor assembly, according to an embodiment of the present disclosure.

### DETAILED DESCRIPTION

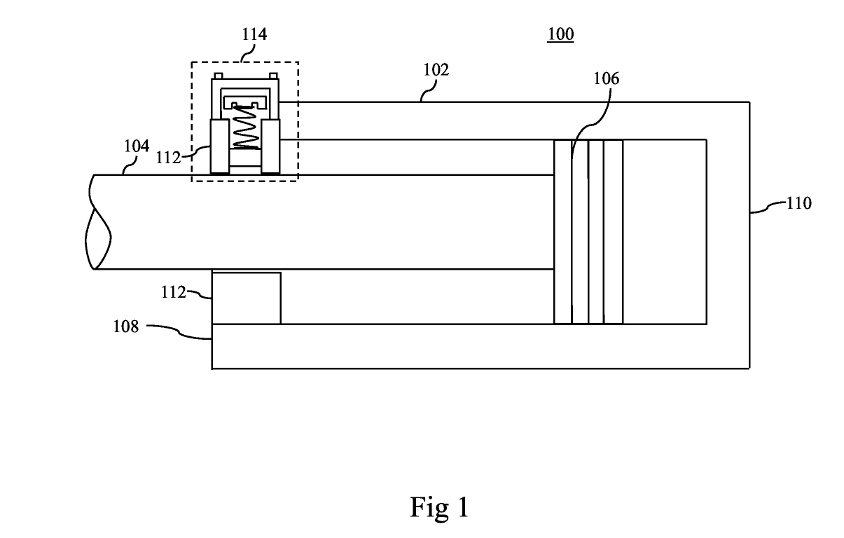

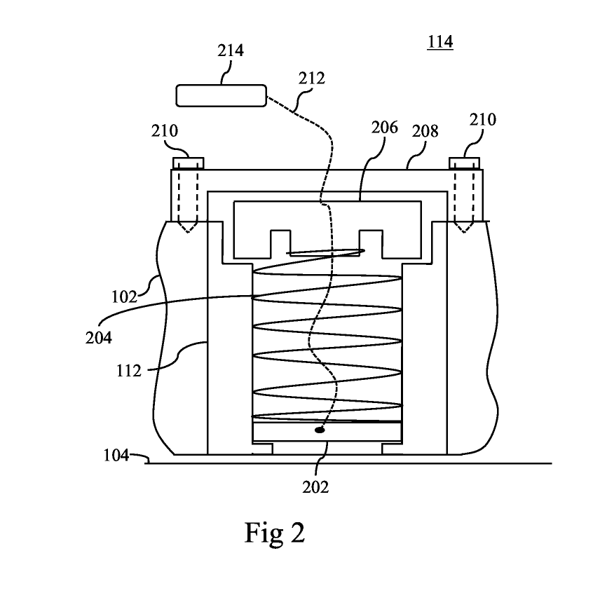

Detailed embodiments of the present disclosure are described herein with reference to FIG. 1 and FIG. 2. The specific structural and functional details disclosed herein are intended to be exemplary and should not be interpreted as limiting the disclosure.

FIG. 1 illustrates a longitudinal sectional view of a cylinder assembly 100, according to an embodiment of the present disclosure. The cylinder assembly 100 includes a cylinder body 102. The cylinder body 102 can be a hollow cylinder configured to house a rod member 104. The rod member 104 can be connected with a piston 106. The piston 106 can be disposed inside the cylinder body 102. The cylinder body 102 is also shown to have a rod end 108, a head end 110, a bearing sleeve 112, and a cylinder position sensor assembly 114.

The rod member 104 may be configured to be connected with the piston 106. The piston 106 can slide within the cylinder body 102 during extension and retraction of the cylinder assembly 100. The rod member 104 can be rigidly connected with the piston 106 and also slides with the piston 106. In other words, the rod member 104 can be installed concentrically inside the cylinder body 102. The rod member 104 may enter the cylinder body 102 from the rod end 108 and can longitudinally slide within the cylinder body 102 in a telescopic motion along with the piston 106. The rod member 104 may be connected to the piston 106 and be supported by the bearing sleeve 112 at the rod end 108. In other words, the bearing sleeve 112 can be rigidly disposed at the rod end 108 of the cylinder body 102 such that the rod member 104 slides within the bearing sleeve 112. The bearing sleeve 112 can be installed in such a way that its outer body is disposed with in the inner wall of the cylinder body 102. The inner body of the bearing sleeve 112 can be configured to support the sliding movement of the rod member 104. It can be contemplated that the bearing sleeve 112 can be cylindrical bushing that may be disposed axially with the rod member 104 and the cylinder body 102. The bearing sleeve 112 may be disposed between the rod member 104 and inner wall of the cylinder body 102 so as to surround the rod member 104. The rod member 104 may slide within the bearing sleeve 112 while in a telescopic motion along with the piston 106.

The bearing sleeve 112 may include a cavity or a hole configured to house the cylinder position sensor assembly 114. The cylinder position sensor assembly 114 may be positioned in proximity to the rod end 108 and radial to the rod member 104. The cylinder position sensor assembly 114 may be configured to sense a position of the rod member 104 while the rod member 104 is in the telescopic motion. The cylinder position sensor assembly 114 has been described further in subsequent description.

FIG. 2 illustrates a fragmentary cutaway view of a cylinder position sensor assembly 114, according to an embodiment of the present disclosure. Referring to FIG. 2, the cylinder position sensor assembly 114 can be mounted in the hole of the bearing sleeve 112 such that the cylinder position sensor assembly 114 is positioned proximate to the rod end 108 of the cylinder body 102. Further, the cylinder position sensor assembly 114 may be mounted in a manner so as to prevent the rotation of the sleeve bearing 112 within the cylinder body 102. The cylinder position sensor assembly 114 may include a cylinder position sensor 202, a spring member 204, a hydraulic cap 206, a flange 208, a pair of bolts 210, a cable member 212 and an electronic system 214.

The cylinder position sensor 202 may be disposed inside the hole or cavity of the sleeve bearing 112 in a manner that the cylinder position sensor 202 is positioned radially and is in close proximity with rod member 104. The cylinder position sensor 202 may be configured to detect a position of the rod member 104. The rod member 104 may slide to extend or retract inside the bearing sleeve 112, and the cylinder position sensor 202 may detect/sense the sliding movement of rod member 104. The cylinder position sensor 202 may be one of a magnetic field sensor, an electromagnetic sensor, an optical sensor, a hydraulic pressure sensor, a capacitive sensor, and resistance based sensors, or the like. In an embodiment, a magnetic field sensor may generate a position signal based on the flux change in the rod member 104. However, it is evident to a person with ordinary skill in the art that type of the cylinder position sensor 202 used, nowhere affects the functionality of the present disclosure.

The cylinder position sensor 202 can be disposed in the cavity or hole in the sleeve bearing 112 and may be held in position by spring force applied by the spring member 204. The spring member 204 may be configured to keep the cylinder position sensor 202 in a pre-specified position. In other words, the cylinder position sensor 202 can be spring loaded by the spring member 204 such that the cylinder position sensor 202 is always disposed in close proximity to rod member 104. The spring member 204 can be sandwiched between the cylinder position sensor 202 and the hydraulic cap 206.

The hydraulic cap 206 may be configured to act as cover and apply a push force on the spring member 204 to compress the spring member 204. Such compressive force may help in keeping the cylinder position sensor 202 in position. The hydraulic cap 206 may be tightly sealed to the cylinder body 102 by the flange 208, to prevent any leakage of fluid from the cylinder body 102.

The flange 208 may be fastened to the cylinder position sensor assembly 114 using the pair of bolts 210 on the cylinder body 102. The flange 208 may be configured to act as a protective cover to protect the cylinder position sensor assembly 114 from dirt, oil and other environmental factors.

The electronic system 214 may be communicably coupled with the cylinder position sensor 202 via the cable member 212. The electronic system 214 may be configured to interpret the signal provided by the cylinder position sensor 202. In an embodiment, the electronic system 214 may essentially include a receiver, a transmitter and a controller. The controller may be a microcontroller or microprocessor. The electronic system 214 may be an analog device or a digital device configured to interpret a position signal corresponding to the position of the rod member 104.

In operation, the cylinder position sensor 202 can be configured to sense the position of the rod member 104 while the rod member 104 moves in a telescopic motion within the cylinder body 102. The cylinder position sensor 202 may generate the position signal based on the sensed position of the rod member 104 and transmit the position signal to the electronic system 214 via the cable member 212. The electronic system 214 may receive the position signal from the cylinder position sensor 202 via the receiver. The controller of the electronic system 214 may process the position signal. The processed position signal is further used to determine the position of the rod member 104 inside the cylinder body 102. In an embodiment the electronic system 214 may be connected wirelessly with the cylinder position sensor 202.

### INDUSTRIAL APPLICABILITY

The disclosed position sensor assembly 114 for cylinder assembly 100 can be used in construction and mining equipment, such as excavators, wheel loaders, backhoe loaders, bulldozers, forklift trucks, graders, scrapers and the like. In the given embodiments of the disclosure, the position sensor assembly 114 can be used to determine the position of the rod member 104. The position sensor assembly 114 can be utilized to implement an automatic control system for lifting or tilting certain work elements like a boom, a stick, and work tools, such as, a bucket, a ripper, a blade and other work tool of construction and mining equipments. The automatic control system increases efficiency and accuracy of an operation while positioning the work tool. It further eliminates operator fatigue and manipulation of the work tool.

In a typical digging operation, an operator of a construction machine has to retract and extend a hydraulic cylinder to control various work elements such as work tool. Also the operator needs to monitor the depth of the work tool to control the digging operation. To dig up a specific depth, the operator needs the current position data of the work tool. The position of the work tool can be determined based on the displacement of the rod member 104. For example, if the operator has to dig deeper, the rod member 104 needs to be extended. Prior to extension, position of the rod member 104 can be determined and then the required extension command can be issued.

The cylinder position sensor assembly 114 as illustrated in FIG. 1 and FIG. 2 can be mounted inside the hole of the bearing sleeve 112. The cylinder position sensor 202 may be configured to detect the position of rod member 104 inside the cylinder body 102. On extension of the rod member 104, the cylinder position sensor 202 may detect the movement of the rod member 104 and generate the position signal. The position signal can be interpreted by the electronic system 214 to determine the extended or retracted position of the rod member 104, hence the position of the work tool. Such information may be configured to automate the extension and retraction process of the rod member 104 inside the cylinder body 102. In other words, the operator may set a required depth of the work tool and the position of the rod member 104 can be adjusted based on the position signal generated by the cylinder position sensor 202.

In the present disclosure, the cylinder position sensor 202 may be mounted inside the hole of bearing sleeve 112. Such a mounting may lead to a more robust cylinder position sensor assembly 114 which further holds the cylinder position sensor 202 securely. Such a mounting may further keep the cylinder position sensor 202 aligned with respect to the rod member 104. The alignment of the cylinder position sensor 202 with respect to the rod member 104 may result in sensing the position of the rod member 104 with greater accuracy. The idea for the present disclosure is of great advantage in industrial applications, earthmoving and material handling machines and vehicles where automated hydraulic cylinders of high accuracy are required.

What is claimed is:

1. A cylinder assembly, comprising:
a cylinder body, wherein the cylinder body is a hollow cylinder comprising an head end and a rod end;
a rod member configured to engage in a telescopic motion within the cylinder body;
a bearing sleeve disposed inside the cylinder body at the rod end, wherein the bearing sleeve comprises a hole; and
a cylinder position sensor assembly mounted in the hole of the bearing sleeve, wherein the cylinder position sensor assembly comprises a cylinder position sensor.
